(19) United States
(12) Patent Application Publication
(10) Pub. No.: US 2012/0127325 A1
(43) Pub. Date: May 24, 2012

(54) Web Camera Device and Operating Method thereof

(75) Inventor: Kun-Hui LAI, TAIPEI CITY (TW)

(73) Assignee: INVENTEC CORPORATION, TAIPEI CITY (TW)

(21) Appl. No.: 13/018,428

(22) Filed: Feb. 1, 2011

(30) Foreign Application Priority Data
Nov. 23, 2010 (TW) 099140410

(51) Int. Cl. H04N 5/225

(52) U.S. Cl. 348/207.1; 348/E05.024

(57) ABSTRACT

A web camera device includes a web camera and a micro processing unit (MCU). The web camera is operable to capture an image of a user. The MCU is electrically connected to the web camera and includes a distance calculating module and a comparing module. The distance calculating module is operable to receive a distance between the user and the web camera based on the calculating of the image. The comparing module is operable to compare the distance with a predetermined distance range, wherein when the distance is beyond the predetermined distance range, the comparing module outputs a warning signal for alarm the user to keep a proper distance from the display. An operating method of the web camera device is disclosed herein.

### RELATED APPLICATIONS

This application claims priority to Taiwan Application Serial Number 099140410, filed Nov. 23, 2010, which is herein incorporated by reference.

### BACKGROUND

1. Field of Invention

The present invention relates generally to a camera device and, more particularly, to a web camera device with eye-protecting function.

2. Description of Related Art

Due to the development of the internet information, computers are popular to many companies so that many office staffs sit at the desk and use the computers day after day. In addition, with the evolution of the computer generation, students also use the computer to surf the internet for information they need or for entertainment, and the online duration is getting longer and longer.

The office staffs or the students suffer from reduced vision when the office staffs or the students use the information products too long, especially when the distance between the eyes of the users and the display is abnormal (too far or too close). The foregoing are the main reasons damaging the eyes of the user.

However, using computers for a long time for the office staffs or the students is unavoidable; therefore, how to keep the distance between the eyes of the user and the display is a key point for protecting the vision of the users.

### SUMMARY

The present invention provides a web camera device whereby the web camera device can keep a proper distance between eyes of the users and a display.

Thus, in one aspect, the present invention provides a web camera device. The web camera device comprises a web camera and a micro processing unit. The web camera is operable to capture an image of a user. The micro processing unit is electrically connected to the web camera. The micro processing unit comprises a distance calculating module and a comparing module. The distance calculating module is operable to obtain a distance between the user and the web camera based on the calculating of the image. The comparing module is operable to compare the distance with a predetermined distance range, and the comparing module outputs a warning signal when the distance is beyond the predetermined distance range.

In one embodiment of the present invention, the micro processing unit further comprises an identifying module. The identifying module is operable to identify a head image of the user from the image, and the distance calculating module calculates the distance between the user and the web camera based on the head image.

In another embodiment of the present invention, the web camera captures the image through an automatic focusing process so that the distance calculating module calculates the distance between the user and the web camera based on a focal length generated from the automatic focusing process by the web camera.

In yet another embodiment of the present invention, the micro processing unit outputs a computer font controlling signal to a computer system based on the distance so that the computer system sets the size of the computer font outputted from the computer system based on the computer font controlling signal.

In still another embodiment of the present invention, the micro processing unit outputs a brightness controlling signal to a computer system based on the distance so that the computer system sets the brightness outputted from the computer system based on the brightness controlling signal.

In another aspect, the present invention provides an operating method of a web camera device. The operating method comprises the steps of capturing an image of a user by a web camera; obtaining a distance between the user and the web camera by processing the image; determining whether the distance is beyond a predetermined distance range; and outputting a warning signal when the distance is beyond the predetermined distance range.

In one embodiment of the present invention, the step of processing the image comprises the step of identifying a head image of the user from the image, and calculating the distance between the user and the web camera based on the head image.

In another embodiment of the present invention, the step of capturing the image of the user comprises the step of capturing the image through an automatic focusing process by the web camera; wherein the step of processing the image comprises the step of calculating the distance between the user and the web camera based on a focal length generated from the automatic focusing process by the web camera.

In yet another embodiment of the present invention, wherein after the step of processing the image, the method further comprises the step of outputting a computer font controlling signal to a computer system based on the distance so that the computer system sets the size of the computer font outputted from the computer system based on the computer font controlling signal.

In still another embodiment of the present invention, wherein after the step of processing the image, the method further comprises the step of outputting a brightness controlling signal to a computer system based on the distance so that the computer system sets the brightness outputted from the computer system based on the brightness controlling signal.

As a result, the present invention provides the web camera device whereby the web camera device can keep a proper distance between the eyes of the user and the display.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 shows schematically a block diagram of a web camera device according to one embodiment of the present invention.

FIG. 2 shows schematically a diagram of an identified head image by an identifying module according to FIG. 1 of the present invention.

FIG. 3 shows schematically a diagram of an automatic focusing function of the web camera according to FIG. 1 of the present invention.

FIG. 4 shows schematically a flow diagram of an operating method of a web camera device according to one embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

FIG. 1 shows schematically a block diagram of a web camera device according to one embodiment of the present invention.

As shown in FIG. 1, the web camera device 100 comprises a web camera 110 and a micro processing unit 120. The web camera 110 is operable to capture an image of a user. The micro processing unit 120 is electrically connected to the web camera 110. The micro processing unit 120 comprises a distance calculating module 122, a comparing module 124, and an identifying module 126.

In addition, the distance calculating module 122 is operable to obtain a distance between the user and the web camera 110 based on the calculating of the image. The foregoing distance is approximately equal to the distance between the eyes of the user and the display; thus, in the whole specification, the distance between the user and the web camera 110 represents the distance between the eyes of the user and the display.

Furthermore, the comparing module 124 is operable to compare the distance with a predetermined distance range, and the comparing module 124 outputs a warning signal when the distance is beyond the predetermined distance range. The identifying module 126 is operable to identify a head image of the user from the image, and the distance calculating module 122 calculates the distance between the user and the web camera 110 based on the head image.

It is noteworthy that the web camera device 100 can be any device having the web camera, for example, a desktop computer, a notebook, or an All in One (AIO) which is equipped with the web camera on the display. For the display, the web camera can be an inner web camera or an external web camera. However, the scope of the present application is not intended to be limited to the embodiment, it should be understood by those skilled in the art that any device which can work together with the web camera without departing from the spirit and scope of the invention as defined by the appended claim can remains within the scope of the present invention.

In practice, the predetermined distance range can be a distance range suitable for a user to view the display; generally, the suitable viewing distance range is about 60 to 70 centimeters, for example. The distance calculating module 122 calculates the distance between the user and the web camera 110 to after the web camera 110 captures the image of the user. The comparing module 124 compares the distance with the predetermined distance range, that is to say, the comparing module 124 determines whether the distance is beyond the predetermined distance range. For example, if the distance between the user and the web camera 110 is about 50 centimeters, this represents that the user is too close to the display; furthermore, the comparing module 124 outputs a warning signal due to the distance is beyond the predetermined distance range.

On the contrary, if the distance between the user and the web camera 110 is 80 centimeters, this represents that the user is too far from the display; furthermore, the comparing module 124 outputs a warning signal due to the distance is beyond the predetermined distance range.

In an optional embodiment, the web camera device 100 can further comprise a warning device such as a horn, a buzzer, or a warning light. The warning device will be turn on when the warning device receives the warning signal so that the user knows that he needs to move for changing the distance between him and the display. Specifically, the user will know that the distance between him and the display is abnormal when the user hears the warning voice or sees the warning light, and he needs to move for changing the distance between him and the display.

Moreover, the warning signal can also be outputted to a computer system. When the computer system receives the warning signal, the computer system can display “Too close to the display, please leave the display” (if the distance between the user and the display is less than the predetermined distance range) or display “Too far from the display, please come close to the display” (if the distance between the user and the display is longer than the predetermined distance range). As a result, the user can adjust the distance between him and the display based on the warnings until the distance is proper in order to protect the eyes of the user. However, the scope of the present application is not intended to be limited to the embodiment, it should be understood by those skilled in the art that the computer system can display different warnings for the actual demand.

It is noteworthy that the distance calculating module 122 of one embodiment of the present invention mainly uses two ways to calculate the distance between the user and the web camera 110. The ways that the distance calculating module 122 uses can be more fully understood by reading the following detailed description of the embodiment.

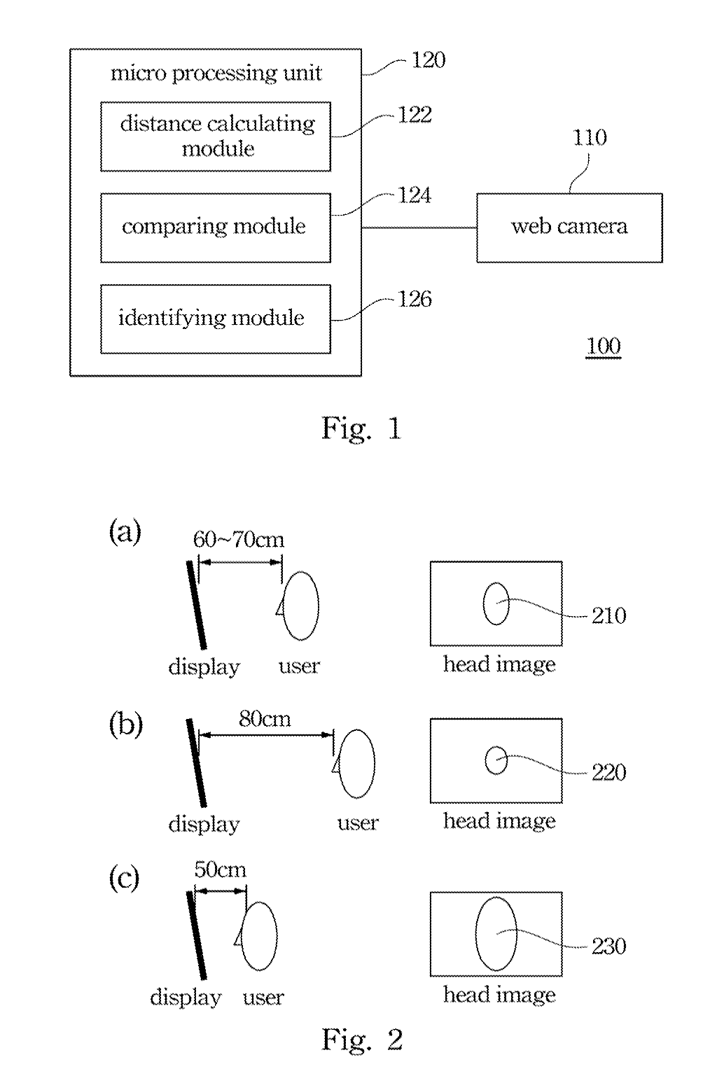

Reference is now made to FIG. 2 which is a schematic diagram illustrating an identified head image by an identifying module according to FIG. 1 of the present invention.

As shown is FIG. 2(a), the user keeps a suitable viewing distance, for example, 65 centimeters, and the camera 110 captures the image of the user. The identifying module 126 then identifies a head image 210 of the user from the image. The distance calculating module 122 establishes a contrast table of the size of the head image and the distance.

As shown is FIG. 2(b), the web camera 110 captures the image of the user when the distance between the user and the web camera 110 changes. The identifying module 126 then identifies the head image 220 from the image, and the distance calculating module 122 can calculate the distance between the user and the web camera 110 due to using the head image 220 to check the contrast table. For example, in FIG. 2(b), the distance between the user and the web camera 110 is about 80 centimeters.

As shown is FIG. 2(c), the way of calculating the distance between the user and the web camera 110 is the same as the way described hereinabove in connection with FIG. 2(b), so the distance calculating module 122 can also calculate the distance between the user and the web camera 110 due to using the head image 230 to check the contrast table. For example, in FIG. 2(c), the distance between the user and the web camera 110 is about 50 centimeters.

In sum, if the predetermined distance range is between about 60 to 70 centimeters, the distance between the user and the web camera 110 in FIG. 2(b) and FIG. 2(c) are all beyond the predetermined distance range. Therefore, the comparing module 124 outputs a warning signal in said two kinds of situations.

As shown in FIG. 2, the web camera device 100 can use another way to determine whether the distance between the user and the web camera 110 is abnormal.

As shown in FIG. 2(a), the web camera 110 captures one image when the distance between the user and the display is at the maximum value of the predetermined distance range (for example: about 70 centimeters) and captures another image when the distance between the user and the display is at the minimum value of the predetermined distance range (for example: about 60 centimeters), and the identifying module 126 identifies the size of the head images of the two images. As such, the web camera device 100 can obtain the size of the head image from the image captured at the maximum value of the predetermined distance range and the size of the head image from the image captured at the minimum value of the predetermined distance range.

As shown in FIG. 2(b), the comparing module 124 obtains the size of the head image 220 when the distance between the user and the web camera 110 is longer than the maximum value of the predetermined distance range (for example: about 80 centimeters), and the comparing module 124 will determine whether the size of the head image 220 is less than the size of the head image captured at the maximum value of the predetermined distance range; if positive, the comparing module 124 outputs a warning signal.

As shown in FIG. 2(c), the comparing module 124 obtains the size of the head image 230 when the distance between the user and the web camera 110 is less than the minimum value of the predetermined distance range (for example: about 50 centimeters), and the comparing module 124 will determine whether the size of the head image 230 is bigger than the size of the head image captured at the minimum value of the predetermined distance range; if positive, the comparing module 124 outputs a warning signal. Thus, the above-mentioned embodiment can be used to determine whether the distance between the user and the web camera 110 is abnormal. The comparing module 124 outputs a warning signal when the distance between the user and the web camera 110 is abnormal so that the computer system with the web camera device 100 can remind the user to care about the distance between the user and the web camera 110.

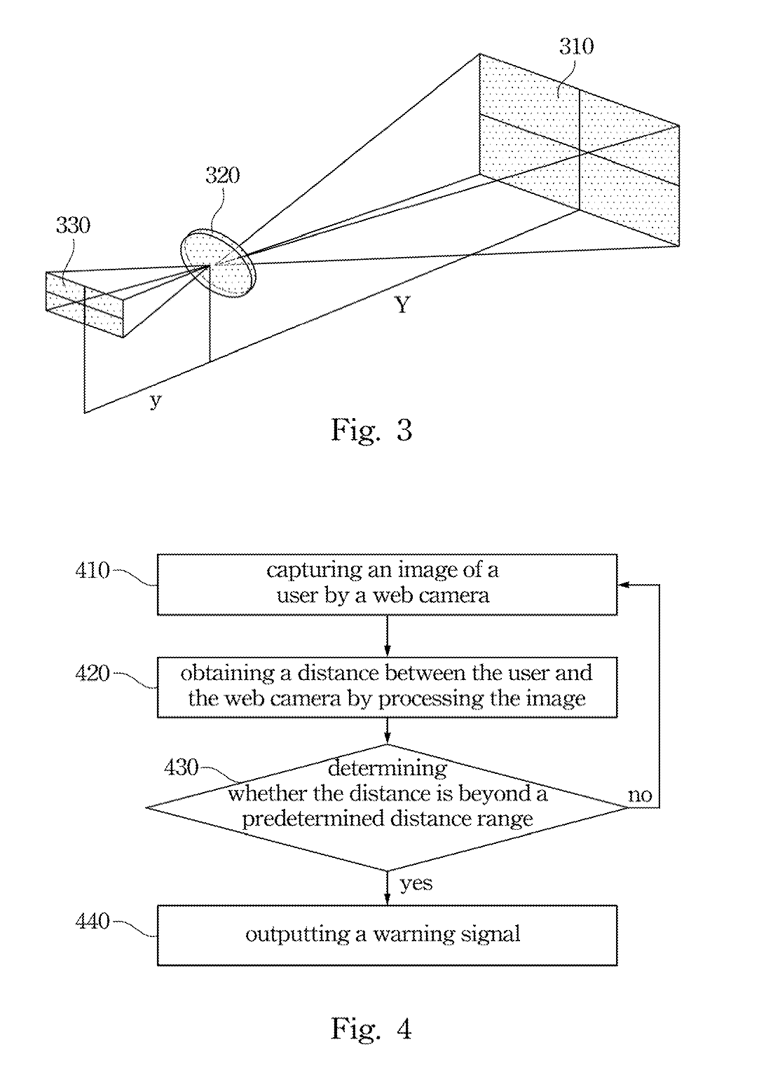

FIG. 3 shows schematically a diagram of an automatic focusing function of the web camera 110 according to FIG. 1 of the present invention.

Reference is now made to FIG. 1 and FIG. 3. As shown in FIG. 3, the small parallelogram at the left side is a focal plane 330, and the focal plane 330 represents where the web camera 110 is configured. The round object in the middle represents the lens 320 of the web camera 110. The big parallelogram at the right side is the main image plane 310, and the main image plane 310 represents where the eyes of the user. The symbol Y represents the distance between the main image plane 310 and the lens 320, that is to say, the symbol Y is the distance between the user and the web camera 110. The symbol y represents the distance between the focal plane 330 and the lens 320.

In practice, the position of the main image plane 310 will change when the user moves, and the web camera 110 can capture the image of the user through an automatic focusing process simultaneously. Specifically, the way the web camera 110 executes the automatic focusing process is to move the lens 320 until the image of the user projects on the focal plane 330 clearly.

After the automatic focusing process is finished, the distance calculating module 122 obtains the length of y, and the length of y is the focal length of the web camera 110. As such, the distance calculating module 122 calculates the length of Y based on the length of y; that is to say, with the use of the focal length, the distance calculating module 122 can calculate the distance between the user and the web camera 110. As a result, the web camera 110 can use the automatic focus function of its own to obtain the distance between the user and the web camera 110 without additional cost so that the computer system with the web camera 100 can remind the user to keep the suitable viewing distance.

In one embodiment, after the distance calculating module 122 obtains the distance between the user and the web camera 110, the micro processing unit 120 can output a computer font controlling signal to a computer system based on the distance so that the computer system sets the size of the computer font outputted from the computer system based on the computer font controlling signal.

For example, the computer system will enlarge the size of the computer font outputted from the computer system based on the computer font controlling signal when the user is far from the web camera 110 so that the user can see the computer font or an image on the display clearly even the user is far from the web camera 110. As a result, the computer system with the web camera 110 can ensure the visual unity and protect the vision of the user. On the contrary, the computer system will decrease the size of the computer font outputted from the computer system based on the computer font controlling signal when the user is near to the web camera 110.

In addition, the micro processing unit 120 outputs a brightness controlling signal to a computer system based on the distance after the distance calculating module 122 obtains the distance between the user and the web camera 110 so that the computer system sets the brightness outputted from the computer system based on the brightness controlling signal.

For example, the computer system will increase the brightness outputted from the computer system based on the brightness controlling signal when the user is far from the web camera 110 so that the user can see the computer font or an image on the display clearly even the user is far from the web camera 110. As a result, the computer system with the web camera device 100 can protect the vision of the user. On the contrary, the computer system will decrease the brightness outputted from the computer system based on the brightness controlling signal when the user is near to the web camera 110.

FIG. 4 shows schematically a flow diagram of an operating method of a web camera device 100 according to one embodiment of the present invention.

Reference is now made to FIG. 1 and FIG. 4. The operating method of the web camera device 100 comprises the steps of:

Step 410: capturing an image of a user by a web camera;

Step 420: obtaining a distance between the user and the web camera by processing the image;

Step 430: determining whether the distance is beyond a predetermined distance; and

Step 440: outputting a warning signal when the distance is beyond the predetermined distance.

In step 420, the distance calculating module 122 can be used to process the image for obtaining the distance between the user and the web camera 110.

In step 430, the comparing module 124 can be used to determine whether the distance is beyond the predetermined distance range. The predetermined distance range can be a distance range suitable for a user to view the display; generally, the suitable viewing distance range is about 60 to 70 centimeters, for example. However, the scope of the present application is not intended to be limited to the embodiment, it should be understood by those skilled in the art that it only exemplifies a suitable viewing distance range for user to view the display.

In step 440, the web camera device 100 can further comprise a warning device such as a horn, a buzzer, or a warning light. The warning device will be turned on when the warning device receives the warning signal so that the user will know that he needs to adjust the distance between him and the display.

Furthermore, if the distance is within the predetermined distance range, proceed to step 410. Thus the web camera device 100 can be used to monitor the distance between the user and the web camera 110, and the web camera device 100 can use its own warning device to remind the user of keeping a proper distance between the user and the web camera 110.

In one operational embodiment, step 420 could be carried out by use of head-image recognition, such as those described hereinabove with respect to the recognition of the head image of the user, and the distance between the user and web camera 110 is calculated based on the thus-obtained head image. In the present embodiment, the identifying module 126 described hereinabove in connection with FIG. 1 may be used to perform the recognition step, and the distance calculating module 124 of FIG. 1 may be used to calculate the distance between the user and the web camera based on the head image. As could be appreciated, the principles of the calculation step have been described hereinabove in connection with FIG. 2, and accordingly, a detailed description regarding the present calculation step is omitted herein for the sake of brevity.

In another operational embodiment, the automatic focus function of the web camera 110 can be used to calculate the distance between the user and the web camera 110. In one embodiment, the automatic focus function of the web camera 110 as mentioned in FIG. 3 can be used to perform the image capturing step of step 410. Accordingly, in step 420, the distance calculating module 124 can obtain a focal length when the automatic focus process of the web camera 110 is completed, and the distance calculating module 124 can calculate the distance between the user and the web camera 110 based on the focal length. The detailed calculating method is mentioned in the description of FIG. 3, and accordingly, a detailed description regarding the present calculation step is omitted herein for the sake of brevity.

In addition, the operating method further comprises the step of outputting a computer font controlling signal to a computer system based on the distance after the step of processing the image so that the computer system sets the size of the computer font outputted from the computer system based on the computer font controlling signal. In this embodiment, the micro processing unit 120 can be used to output a computer font controlling signal to a computer system based on the distance.

For example, the computer system will enlarge the size of the computer font outputted from the computer system based on the computer font controlling signal when the user is far from the web camera 110 so that the user can see the computer font or an image on the display clearly even if the user is far from the web camera 110. As a result, the computer system with the web camera 110 can ensure the visual unity and protect the vision of the user. On the contrary, the computer system will decrease the size of the computer font outputted from the computer system based on the computer font controlling signal when the user is near to the web camera 110.

Moreover, the operating method further comprises the step of outputting a brightness controlling signal to a computer system based on the distance after the step of processing the image so that the computer system sets the brightness outputted from the computer system based on the brightness controlling signal. In this embodiment, the micro processing unit 120 can be used to output a brightness controlling signal to a computer system based on the distance.

In addition, the micro processing unit 120 outputs a brightness controlling signal to a computer system based on the distance after the distance calculating module 122 obtains the distance between the user and the web camera 110 so that the computer system sets the brightness outputted from the computer system based on the brightness controlling signal.

For example, the computer system will increase the brightness outputted from the computer system based on the brightness controlling signal when the user is far from the web camera 110 so that the user can see the computer font or an image on the display clearly even the user is far from the web camera 110. As a result, the computer system with the web camera 110 can protect the vision of the user. On the contrary, the computer system will decrease the brightness outputted from the computer system based on the brightness controlling signal when the user is near to the web camera 110.

Above all, the web camera device 100 can keep a suitable viewing distance. Furthermore, the web camera 110 with the automatic focus function can calculate the distance between the user and the web camera 110 for reminding the user of keeping a suitable viewing distance without additional cost.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A web camera device comprising:
a web camera for capturing an image of a user; and
a micro processing unit electrically connected to the web camera, wherein the micro processing unit comprises:
a distance calculating module for obtaining a distance between the user and the web camera based on the calculating of the image;
a comparing module for comparing the distance with a predetermined distance range, wherein when the distance is beyond the predetermined distance range, the comparing module outputs a warning signal.

2. The web camera device according to claim 1, wherein the micro processing unit further comprises an identifying module for identifying a head image of the user from the image, and the distance calculating module calculates the distance between the user and the web camera based on the head image.

3. The web camera device according to claim 1, wherein the web camera captures the image through an automatic focusing process so that the distance calculating module calculates the distance between the user and the web camera based on a focal length generated from the automatic focusing process by the web camera.

4. The web camera device according to claim 2, wherein the web camera captures the image through an automatic focusing process so that the distance calculating module calculates the distance between the user and the web camera based on a focal length generated from the automatic focusing process by the web camera.

5. The web camera device according to claim 1, wherein the micro processing unit outputs a computer font controlling signal to a computer system based on the distance so that the computer system sets the size of the computer font outputted from the computer system based on the computer font controlling signal.

6. The web camera device according to claim 2, wherein the micro processing unit outputs a computer font controlling signal to a computer system based on the distance so that the computer system sets the size of the computer font outputted from the computer system based on the computer font controlling signal.

7. The web camera device according to claim 3, wherein the micro processing unit outputs a computer font controlling signal to a computer system based on the distance so that the computer system sets the size of the computer font outputted from the computer system based on the computer font controlling signal.

8. The web camera device according to claim 4, wherein the micro processing unit outputs a computer font controlling signal to a computer system based on the distance so that the computer system sets the size of the

[symbol]

9. The web camera device according to claim 1, wherein the micro processing unit outputs a brightness controlling signal to a computer system based on the distance so that the computer system sets the brightness outputted from the computer system based on the brightness controlling signal.

10. The web camera device according to claim 2, wherein the micro processing unit outputs a brightness controlling signal to a computer system based on the distance so that the computer system sets the brightness outputted from the computer system based on the brightness controlling signal.

11. The web camera device according to claim 3, wherein the micro processing unit outputs a brightness controlling signal to a computer system based on the distance so that the computer system sets the brightness outputted from the computer system based on the brightness controlling signal.

12. The web camera device according to claim 4, wherein the micro processing unit outputs a brightness controlling signal to a computer system based on the distance so that the computer system sets the brightness outputted from the computer system based on the brightness controlling signal.

13. The web camera device according to claim 6, wherein the micro processing unit outputs a brightness controlling signal to a computer system based on the distance so that the computer system sets the brightness outputted from the computer system based on the brightness controlling signal.

14. The web camera device according to claim 7, wherein the micro processing unit outputs a brightness controlling signal to a computer system based on the distance so that the computer system sets the brightness outputted from the computer system based on the brightness controlling signal.

15. The web camera device according to claim 8, wherein the micro processing unit outputs a brightness controlling signal to a computer system based on the distance so that the computer system sets the brightness outputted from the computer system based on the brightness controlling signal.

16. An operating method of a web camera device comprising the steps of:
capturing an image of a user by a web camera;
obtaining a distance between the user and the web camera by processing the image;
determining whether the distance is beyond a predetermined distance range; and
outputting a warning signal when the distance is beyond the predetermined distance range.

17. The operating method according to claim 16, wherein the step of processing the image comprises the step of:
identifying a head image of the user from the image, and calculating the distance between the user and the web camera based on the head image.

18. The operating method according to claim 16, wherein the step of capturing the image of the user comprises the step of:
capturing the image through an automatic focusing process by the web camera;
wherein the step of processing the image comprises the step of:
calculating the distance between the user and the web camera based on a focal length generated from the automatic focusing process by the web camera.

19. The operating method according to claim 16, wherein after the step of processing the image, the method further comprises the step of:
outputting a computer font controlling signal to a computer system based on the distance so that the computer system sets the size of the computer font outputted from the computer system based on the computer font controlling signal.

20. The operating method according to claim 16, wherein after the step of processing the image, the method further comprises the step of:
outputting a brightness controlling signal to a computer system based on the distance so that the computer system sets the brightness outputted from the computer system based on the brightness controlling signal.
